(19) United States
(12) Patent Application Publication
(10) Pub. No.: US 2017/0269984 A1
(43) Pub. Date: Sep. 21, 2017

(54) SYSTEMS AND METHODS FOR IMPROVED DETECTION OF PROCESSOR HANG AND IMPROVED RECOVERY FROM PROCESSOR HANG IN A COMPUTING DEVICE

(71) Applicant: QUALCOMM INCORPORATED, SAN DIEGO, CA (US)

(72) Inventors: ANANTHA IDAPALAPATI, SAN DIEGO, CA (US); AJAYKUMAR SHANKARGOUDA PATIL, BANGALORE (IN); SUBODH SINGH, BANGALORE (IN); RAMSWAROOP SOMANI, ICHALKARANJI (IN); GOPI KRISHNA NEDANURI, HYDERABAD (IN); PAWAN CHHABRA, BANGALORE (IN); SARBARTHA BANERJEE, BANGALORE (IN); VICTOR WONG, SAN DIEGO, CA (US)

(21) Appl. No.: 15/075,011

(22) Filed: Mar. 18, 2016

(51) Int. Cl. G06F 11/07; G06F 13/24; G06F 11/14; G06F 13/28

(52) U.S. Cl. CPC G06F 11/0757; G06F 13/28; G06F 13/24; G06F 11/1441

(57) ABSTRACT

Systems and methods are disclosed for improved processor hang detection. An exemplary method comprises setting a timer with a hang threshold value for each of a plurality of processors of a system on a chip (SoC). The hang threshold value represents a time in microseconds. The method further comprising receiving a first heartbeat signal from each of the plurality of processors with detection logic hardware of a hang controller coupled to the plurality of processors and to the timer. The timer is reset for each of the plurality of processors if a second heartbeat signal is received from the corresponding one of the plurality of processors before the timer expires. Alternatively, a hang event notification is generated if the second heartbeat signal is not received from the corresponding one of the plurality of processors before the timer expires.

### DESCRIPTION OF THE RELATED ART

Computing devices comprising at least one processor coupled to a memory are ubiquitous. Computing devices may include personal computing devices (PCDs) such as desktop computers, laptop computers, portable digital assistants (PDAs), portable game consoles, tablet computers, cellular telephones, smart phones, and wearable computers. In order to meet the ever-increasing processing demands of users, PCDs increasingly incorporate multiple processors or cores running instructions or threads in parallel.

However, such use of multiple processors can lead to significant problems if one core or processor becomes “hung” or unable to programmatically make progress on a task because of a hardware issue, such as processor or system deadlock. Existing “processor hang” solutions depend on software detection mechanisms which are ineffectual to detect processor hang that results from a hardware issue. Additionally, existing back-up watchdog methods that may detect processor hang from a hardware issue only come into play after a relatively long period of time, on the order of multiple seconds.

Such a long period of time with a hung processor can result in the other processors or components of a PCD becoming hung themselves, resulting in a catastrophic event for the PCD. Alternatively, a long period of time with a hung processor can result in the other processors or components of a PCD operating unchecked which may lead to other issues, such as the other processors or components staying active and leaking power while waiting on the hung processor, causing thermal issues.

Accordingly, there is a need for improved systems and methods to quickly detect processor hang in a PCD, and/or to better recover from such processor hang, especially where such processor hang is caused by a hardware issue.

### SUMMARY OF THE DISCLOSURE

Systems, methods, and computer programs are disclosed for implementing processor hang detection in a personal computing device (PCD). An exemplary method includes setting a timer with a hang threshold value for each of a plurality of processors of a system on a chip (SoC). The hang threshold value representing a time in microseconds. A first heartbeat signal from each of the plurality of processors is received at a detection logic hardware of a hang controller, the detection logic hardware coupled to the plurality of processors and to the timer. The timer for each of the plurality of processors is reset if a second heartbeat signal is received from the corresponding one of the plurality of processors before the timer expires. Otherwise, a hang event notification is generated by the hang controller if the second heartbeat signal is not received from the corresponding one of the plurality of processors before the timer expires.

In another embodiment, a computer system for improved processor hang detection in a portable computing device (PCD) is provided. The system comprises a system-on-a-chip (SoC) with a plurality of processors. Each of the plurality of processors is configured to generate a heartbeat signal indicating that the respective one of the plurality of processors is programmatically executing instructions. The system also comprises a hang controller in communication with each of the plurality of processors. The hang controller includes a timer set with a hang threshold value for each of the plurality of processors. The hang threshold value representing a time in microseconds.

The hang controller also includes detection logic hardware in communication with the timer and the plurality of processors. The detection logic hardware is configured to receive a first heartbeat signal from each of the plurality of processors and to: either reset the timer for each of the plurality of processors if a second heartbeat signal is received from the corresponding one of the plurality of processors before the timer expires; or generate a hang event notification if the second heartbeat signal is not received from the corresponding one of the plurality of processors before the timer expires.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of an embodiment of a system for implementing improved detection of processor hang and improved recovery from processor hang in an exemplary computing device;

FIG. 2 is a functional diagram showing an exemplary interaction of portions of the system of FIG. 1 during operation;

FIG. 3 is a flowchart illustrating an embodiment of a method for providing improved detection of processor hang;

FIG. 4 is a flowchart illustrating an exemplary method for detecting and responding to a processor or CPU hang condition;

FIG. 5 is a flowchart illustrating an additional method for providing improved detection of processor hang; and

FIG. 6 is a block diagram of an exemplary computing device in which the system of FIG. 1 or method of FIGS. 3-5 may be implemented.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” or “image” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the term “computing device” is used to mean any device implementing a processor (whether analog or digital) in communication with a memory, such as a desktop computer, gaming console, or server. A “computing device” may also be a “portable computing device” (PCD), such as a laptop computer, handheld computer, or tablet computer. The terms PCD, “communication device,” “wireless device,” “wireless telephone”, “wireless communication device,” and “wireless handset” are used interchangeably herein. With the advent of third generation (“3G”) wireless technology, fourth generation (“4G”), Long-Term Evolution (LTE), etc., greater bandwidth availability has enabled more portable computing devices with a greater variety of wireless capabilities. Therefore, a portable computing device may also include a cellular telephone, a pager, a smartphone, a navigation device, a personal digital assistant (PDA), a portable gaming console, a wearable computer, or any portable computing device with a wireless connection or link.

In order to meet the ever-increasing processing demands placed on PCDs, PCDs increasingly incorporate multiple processors or cores (such as central processing units or “CPUs”) running various threads in parallel. However, these increasing demands, and the use of multiple CPUs can lead to significant problems if one CPU or processor becomes “hung.” “CPU hang” as used herein refers to a situation where the CPU is unable to programmatically make progress for a certain finite period of time because of a hardware issue, such as CPU or system deadlock. CPU hang solutions that depend entirely on software detection mechanisms cannot typically detect CPU hang that results from a hardware issue. Instead, the path on which such software mechanisms rely become inoperative if a CPU hangs because of a hardware issue. Additionally, watchdog methods that may detect CPU hang only act after a relatively long period of time, on the order of multiple seconds.

The system and methods of the present disclosure implement a hardware solution that detects and monitors signals from each CPU of a system on a chip (SoC) that indicate the CPU is still operating (referred to herein at “heartbeat” signals). If a heartbeat signal is not detected by the hardware component for a particular CPU within a pre-established threshold, the CPU is determined to be hung and recovery action is taken. The system and methods allow for significantly quicker detection of CPU hang than is possible with existing solutions, detecting CPU hang in microseconds (μS) rather than seconds.

Such rapid detection of CPU hang provides several benefits not possible with current solutions. For example, the systems and methods of the present disclosure allow for recovery from CPU hang, including reset of the CPU and/or SoC much earlier, and possibly before a user notices the CPU hang, resulting in an improved user experience. Additionally, rapid detection of CPU hang allows for recovery of the hung CPU before the hung CPU causes further issues (such as hanging other components of the PCD), without having to reset the entire PCD. Similarly, rapid detection of CPU hang, and detection at the CPU level, allows for relevant diagnostic information to be captured closer to the point of fault and before the diagnostic information is altered or overwritten by other active system components. Finally, immediate detection of hung CPUs can improve thermal mitigation of the PCD, such as for instance thermal issues caused by not only the hung PCU leaking power, but also the other CPUs or system components burning active power while waiting on the hung CPU.

Although discussed herein in relation to PCDs, the systems and methods herein—and the considerable savings made possible by the systems and methods—are applicable to any computing device.

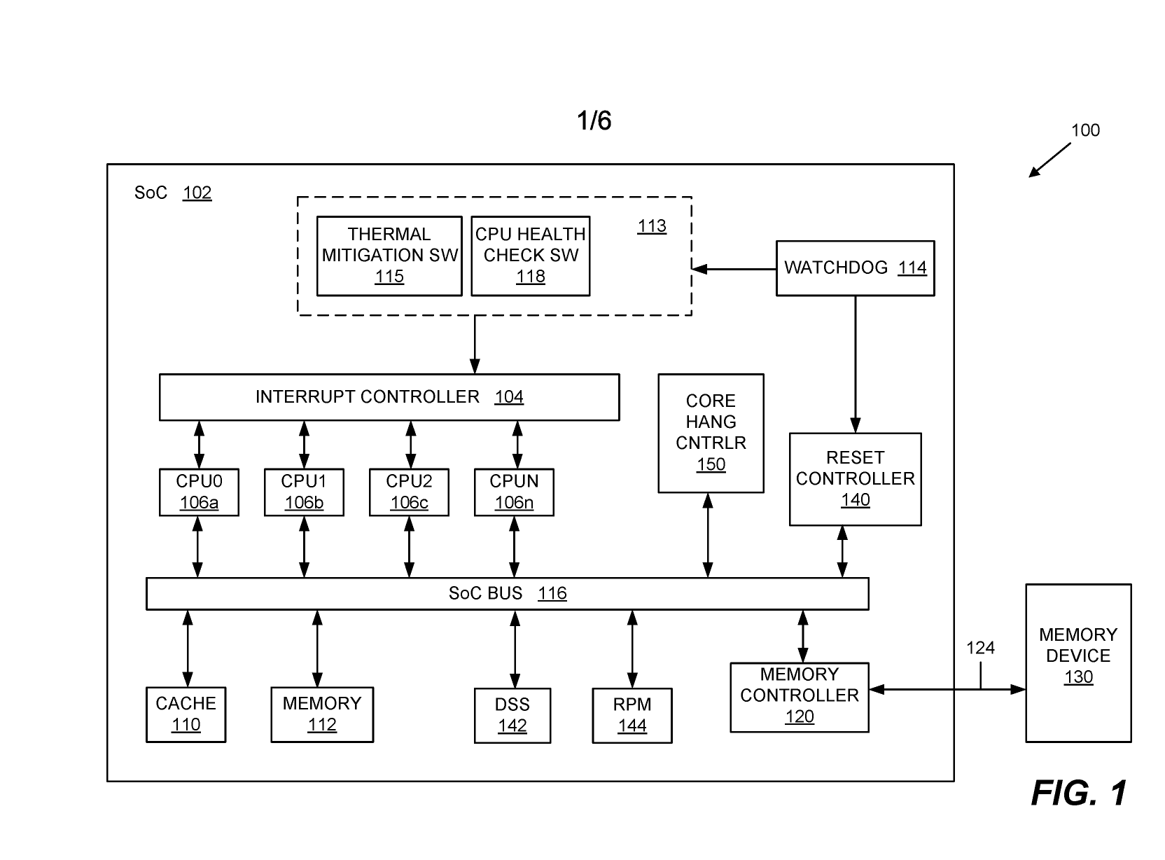

FIG. 1 illustrates an embodiment of a system 100 for implementing improved detection of CPU hang and improved recovery from CPU hang in a system-on-a-chip (SoC) 102. The system 100 may be implemented in any computing device, including a personal computer, a workstation, a server, or a PCD. The system 100 may also be implemented in a computing device that is a portion/component of another product such as an appliance, automobile, airplane, construction equipment, military equipment, etc.

As illustrated in the embodiment of FIG. 1, the system 100 comprises an SoC 102 electrically coupled to an external or “off chip” memory device 130. The SoC 102 comprises various “on chip” components, including multiple central processing unit (CPUs) represented by CPU0 106a, CPU1 106b, CPU2 106c, and CPUN 106n (collectively referred to as CPUs 106a-106n). Although only four CPUs are illustrated in FIG. 1, it will be understood that the present disclosure is not limited to four CPUs and is applicable to any number of desired CPUs.

Additionally, the SoC 102 may include other on chip components, such as a memory controller 120, a cache 110 memory, and a system memory 112, all interconnected via a SoC bus 116. As will be understood, the SoC 102 of FIG. 1 is for illustrative purposes. In other embodiments SoC 102 may contain more or fewer components than illustrated in FIG. 1.

One of the CPUs, such as CPU0 106a may be controlled by or execute an operating system (OS) that causes CPU0 106a to operate or execute various applications, programs, or code stored in one or more memory of the computing device. In some embodiments one or more of CPU0 106a, CPU1 106b, CPU2 106c and CPUN 106n may be the same type of processor. In other embodiments, one or more of CPU1 106b, CPU2 106c, and CPUN 106n may be a digital signal processor (DSP), a graphics processing unit (GPU), an analog processor, or other type of processor different from CPU1 106a executing the OS.

The cache 110 memory of FIG. 1 may be an L2, L3, or other desired cache. Additionally the cache 110 may be dedicated to one processor, such as CPU 106, or may be shared among multiple processors in various embodiments, such as CPUs 106a-106n illustrated in FIG. 1. In an embodiment, the cache 110 may be a last level cache (LLC) or the highest (last) level of cache that the CPU 106 calls before accessing a memory like memory device 130.

System memory 112 may be a static random access memory (SRAM), a read only memory (ROM) 112, or any other desired memory type, including a removable memory such as an SD card. Memory controller 120 is electrically connected to the SoC bus 116 and also connected to the memory device 130 by a memory access channel 124 which may be a serial channel or a parallel channel in various embodiments. Memory controller 120 manages the data read from and/or stored to the various memories accessed by the SoC 102 during operation of the system 100, including memory device 130 illustrated in FIG. 1.

In the illustrated embodiment of FIG. 1, the memory controller 120 may include other portions not illustrated such as a read and/or write buffer, control logic, etc., to allow memory controller 120 to control the data transfer over the memory access channel 124. In various implementations, some or all of the components of the memory controller 120 may be implemented in hardware, software, or firmware as desired. The memory device 130 interfaces with the SoC 102 via a high-performance memory bus comprising an access channel 124, which may be any desired width. The memory device 130 may be any volatile or non-volatile memory, such as, for example, DRAM, flash memory, flash drive, a Secure Digital (SD) card, a solid-state drive (SSD), or other types.

The SoC 102 of the system 100 also includes an interrupt controller 104 in communication with each of CPUs 106a-106n. Interrupt controller 104 provides interrupts to, and receives responses to interrupts from, each of CPUs 106a-106n. In an embodiment, interrupt controller 104 may also provide interrupts to other components of the SoC 102 or processes operating on the SoC 102 (not illustrated), such as interrupts to various drivers used by one or more of CPUs 106a-106n. The SoC 102 may also include various system software 113 in communication with interrupt controller 104. System software 113 may be operated by one or CPUs 106a-106n, or which may be operated on or by a dedicated processor.

System software 113, may in an embodiment include CPU health check software 118, which may be software interrupt based and may provide interrupts to one or more of CPUs 106a-106n though interrupt controller 104 based on detected issues or problems with one or more CPUs. System software 113 may also include thermal mitigation software 115. Thermal mitigation software 115 may implement various thermal mitigation policies for the SoC 102, and may provide interrupts to various drivers through interrupt controller 104.

SoC 102 may also include a watchdog 114 component in communication with the system software 113 and a reset controller 140 that is also in communication with the SoC bus 116. Although not illustrated in FIG. 1, watchdog 114 may include a countdown timer. Watchdog 114 may provide interrupts or signals to system software 113 based on the expiration of the timer, which is generally measured in seconds. As discussed above, the CPU health check software 118 and/or thermal mitigation software 115 may not be effective to detect or mitigation a hang condition at one or more of CPUs 106a-106n. In the event that the system software 113 does not act on the interrupts or signals from the watchdog 114, the watchdog 114 may then send a signal to the reset controller 140. Reset controller 140 may be a hardware component, software component or combination of hardware and software that causes the SoC 102 to reset upon receiving the signal from the watchdog 114.

The SoC 102 also includes a core hang controller 150 coupled to each of CPUs 106a-106n, such as through the SoC bus 116 as illustrated in FIG. 1. In other embodiments, the core hang controller 150 may be directly coupled to CPUs 106a-106n in addition to, or rather than, being coupled through SoC bus 116. In an embodiment core hang controller 150 is electrically coupled to the output of each of CPUs 106a-106n such that one or more signals from CPUs 106a-106n may be received or monitored by core hang controller 150.

In an embodiment, the signal received or monitored by core hang controller 150 is a signal from each of CPUs 106a-106n indicating that CPUs 106a-106n are still operating properly and/or a signal from which core hang controller 150 may determine whether any of CPUs 106a-106n are hung (referred to herein as a “heartbeat” signal). Although illustrated as a single component in FIG. 1 in communication with CPUs 106a-106n, core hang controller 150 may in other embodiments comprise a separate core hang controller 150 for each CPU 106a-106n. Additionally, as discussed below, core hang controller 150 is at least partially comprised of a hardware element or logic, but may also include additional components or elements not illustrated in FIG. 1, including software elements.

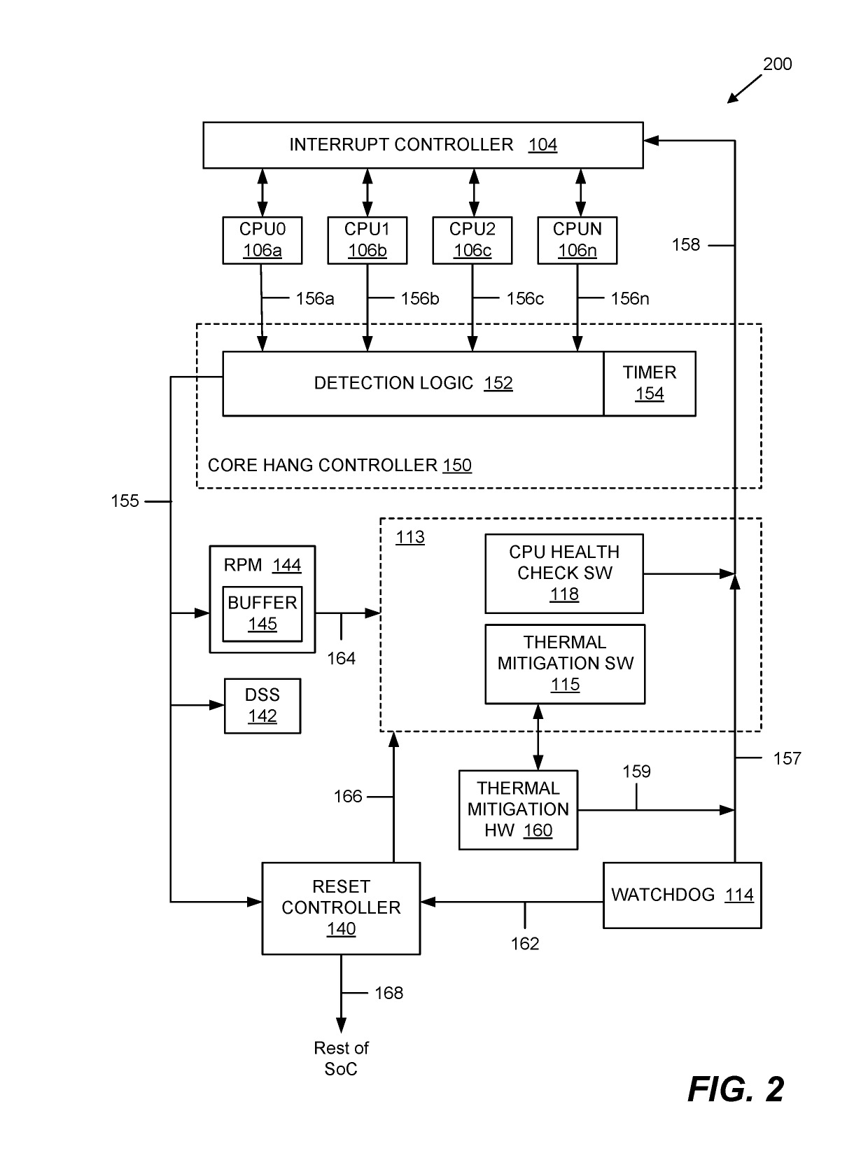

Core hang controller 150 is coupled to reset controller 140, such as through SoC bus 116 as illustrated in FIG. 1, or through any other desired electrical connection. Core hang controller 150 is also coupled to resource power manager 144 and decision support software 142. Resource power manager 144 may comprise its own processor as well as other components (not illustrated) including a memory such as a buffer for storing information or data that may be used to diagnose a hung CPU (see FIG. 2). Decision support software 142 may be software or logic to assist in the determination whether to recover a hung CPU 106a-106n that is detected by core hang controller 150, whether to reset the CPU 106a-106n, or whether to reset the entire SoC 102.

In the illustrated embodiment, resource power manager 144 and decision support software 142 as shown as two separate components. In other implementations, the resource power manager 144 and decision support software 142 (or the functionality of these components) may be combined into one component. Similarly, one or both of resource power manager 144 or decision support software 142 may be combined with the reset controller 140 into a single component in some implementations.

In an embodiment, the reset controller 140, resource power manager 144 and decision support software 142 are all coupled to an output of the core hang controller 150 (see FIG. 2). In such embodiments, upon detection that one or more of CPUs 106a-106n is hung, the core hang controller 150 may send a signal to each of reset controller 140, resource power manager, and decision support software 142. One or more of reset controller 140 resource power manager 144, and/or decision support software 142 may then act to attempt to recover the hung CPU 106a-106n, to reset the hung CPUs 106a-106n, or to reset the SoC 102 (or a combination of these actions).

Core hang controller 150 allows for the rapid detection of hangs by any of CPUs 106a-106n resulting from hardware issues. In an embodiment, core hang controller may accomplish this rapid detection by monitoring the heartbeat signals from each of CPUs 106a-106n. FIG. 2 is a functional diagram showing an exemplary interaction of portions of the system of FIG. 1 during operation in an exemplary embodiment. As illustrated in FIG. 2, core hang controller 150 may comprise detection logic 152 and a timer 154.

In an embodiment the detection logic 152 is a hardware component electrically coupled to the output of each of CPUs 106a-106n to be monitored for CPU hang. During operation, detection logic 152 receives a periodic heartbeat signal 156a-156n from each of CPUs 106a-106n indicating that each of CPUs 106a-106n are still programmatically executing instructions and therefore not hung. In an embodiment where CPUs 106a-106n are Advanced RISC Machine (ARM) based or complaint processors, the heartbeat signals 156a-156n may be Performance Monitoring Unit (PMU) exported events from CPUs 106a-106n that detection logic 152 is configured to receive and/or understand.

For example, an instruction_retired message generated by ARM-based processors for performance measurement may also be received by detection logic 152 of the core hang controller 150. Such instruction_retired messages may be used by the detection logic 152 as the heartbeat signals 156a-156n to determine that CPUs 106a-106n are still programmatically executing instructions and therefore not hung. Note that other messages or signals, such as from non-ARM-based processors may also be used as the heartbeat signals 156a-156n. It is not necessary that the same type of heartbeat signal 156a-156n be used for all of CPUs 106a-106n. For example the type of message or signal used as heartbeat signal 156a for CPU0 106a may be a different signal or message that is used as the heartbeat signal 156b for CPU1 106b.

Timer 154 of the core hang controller 150 may be a software component. In operation, timer 154 or a portion of timer 154 is reset for each CPU 106a-106n when a heartbeat signal 156a-156n is received for the respective CPU 106a-106n. As long as the heartbeat signal 156a-156n is received before the timer 154 expires, the core hang controller 150 knows that none of the CPUs 106a-106n are hung. However, if the timer 154 expires for any of CPUs 106a-106n, the core hang controller 150 knows or determines that the CPU(s) 106a-106n for which the timer 154 has expired is hung. In that event core hang controller 150 may sent an hang event notification 155 to resource power manager 144, decision support software 142 and reset controller 140. Although illustrated as a single component of core hang controller 150, timer 154 may instead be implemented as multiple individual timers 154 (not illustrated) each of the multiple timers 154 associated with one of the CPUs 106a-106n.

Timer 154 is programmable with at least a hang threshold value for each CPU 106a-106n to be monitored. The hang threshold value represents a length of time for the timer 154 to count down for each CPU 106a-106n before the core hang controller 150 will deem or determine the CPU 106a-106n to be hung and no longer programmatically executing tasks. The hang threshold value is determined or set at a value or length of time that ensures long latency operations, such as operations that typically take a few hundred processor cycles to complete do not cause the timer 154 to expire while a CPU 106a-106n is still executing the long latency operations. A complex single instruction multiple data (SIMD) floating point operation, or a memory access to a relatively slow peripheral are examples of such long latency operations.

Even accounting for such long latency operations, the hang threshold value will typically be measured in microseconds (μS) or milliseconds (mS), rather than the multiple seconds required for a typical watchdog 114. Thus, the timer 154 in connection with the detection logic 152 hardware allow the core hang controller 150 to detect a processor or CPU hang much quicker than a typical watchdog 114, and to detect processor or CPU hang closer in location to the hardware issue causing the hung condition.

The hang threshold value for each CPU 106a-106n may be different and may depend on the architecture, use to which the CPU 106a-106n may be put, etc. In an embodiment, this threshold value may be set or programmed for each CPU 106a-106n at initialization of the SoC 102. In some embodiments, the threshold value may be re-programmed for one or more CPUs 106a-106n during operation of the SoC 102 if desired. Additionally, in some embodiments the timer 154 for each CPU 106a-106n may have different threshold values for different states or conditions of the CPU 106a-106n.

For example, the timer 154 associated with CPU 106a may have a first threshold value that is applied for a “power up” operating state such as when the CPU 106a is coming out of a low or reduced power mode. The timer 154 associated with CPU 106a may also have a second threshold value that is applied for a “normal” operating state—i.e. when the CPU 106a is operating at a “full” power mode or state. As will be understood, it is possible to have multiple hang threshold values for each CPU 106a-106n and to have a different number of threshold values (and different value programmed for the threshold values) for each of the different CPUs 106a-106n.

In operation of the system 200 of FIG. 2, once the hang threshold value is determined and set, the timer 154 begins to count down to the hang threshold values for each of CPU 106a-106n. When a heartbeat signal 156a is received for CPU0 106a for example, the timer 154 for CPU0 106a is reset. Similarly, when a heartbeat signal 156b is received for CPU1 106b, the timer 154 for CPU1 106b is reset. The same is true for all of the CPUs 106a-106n to which the timer 154 is associated, regardless of the number of CPUs.

Continuing with the example, if a subsequent or second heartbeat signal 156a is received by the detection logic 152 before the timer 154 associated with CPU0 106a expires, the timer 154 is reset. Similarly, if a subsequent or second heartbeat signal 156b is received by the detection logic 152 before the timer 154 associated with CPU1 106b expires, the timer 154 is reset. The timer 154 continues to be reset as long as the heartbeat signals 156a-156n are received before the timer 154 for the CPUs 106a-106n expires.

If the timer 154 expires for any of CPUs 106a-106n before a second or subsequent heartbeat signal 156a-156n is received the core hang controller 150 determines or deems a processor hang for that particular CPU 106a-106n. The core hang controller 150 then generates a hang event notification 155. In an embodiment, the hang event notification 155 is generated by a hardware component of the core hang controller such as detection logic 152. The hang event notification 155 may be a message or signal that identifies at least which CPU 106a-106n is hung. In some embodiments the hang event notification 155 may also provide additional information, such as whether this is the first, second, third, etc., time the particular CPU 106a-106n has hung, of how many times the CPU 106a-106n has hung in a specified time period, etc.

The hang event notification 155 is received by one or more of the resource power manager 144, decision support software 142, and reset controller 140. In an embodiment, the core hang controller 150 may include logic to determine which component(s) to send hang event notification 155 to. In such embodiments, the logic of the core hang controller 150 may base such determination at least in part on the type of desired action in response to the hang event notification 155.

For example, the logic of the core hang controller 150 may determine that an attempt to recover a hung CPU0 106a without reset of the CPU0 106a or the entire SoC 102 is desirable or warranted under the circumstances. In that event, core hang controller 150 may send the hang event notification 155 to the resource power manager 144. The resource power manager 144 may in turn issue a recovery command 164, such as to the software 113 to attempt to recover the hung CPU0 106a.

On the other hand, in the above example the logic of the core hang controller 150 may determine that an attempt to recover a hung CPU0 106a is not desirable or warranted. Instead the determination may be that the conditions warrant a reset of the hung CPU0 106a or the entire SoC 102. Such a determination may be made, for example when one or more previous attempts to recover the hung CPU0 106a have been unsuccessful. Core hang controller 150 may in this situation decide to send the hang event notification 155 to the reset controller 140. Reset controller 140 may in turn generate a reset command 166 for the particular hung CPU0 106a, such as by issuing a reset command 166 to software 113 as illustrated in FIG. 2. Reset controller 140 may instead generate a system reset command 168 to reset the entire SoC 102. The determination of whether to reset the hung CPU0 106a or the entire SoC 102 may be made in an embodiment by the core hang controller 150, in which case the hang event notification 155 to the reset controller 140 may contain information or instructions telling the reset controller 140 how to proceed.

As will be understood, the decisions and determinations how to respond to a hung CPU, such as CPU0 106a in the above example, may instead be made wholly or in part at resource power manager 144, decision support software 142, reset controller 140, or a combination of these components. In such embodiments, the core hang controller 150 may provide the hang event notification 155 with the information about the hung processor, CPU0 106a. Based on the information in the hang event notification 155, one or more of resource power manager 144, decision support software 142, reset controller 140, or a combination of these components may determine what action to take. As discussed above, a determination may be made by one or more of the above components, acting alone or in connection with other, to first attempt to recover the hung processor such as CPU0 106a, without resetting either the CPU0 106a or the SoC 102. In that event, the resource power manager 144 may determine to first issue a recovery command 164, such as to the software 113 to attempt to recover the hung CPU0 106a.

Resource power manager 144, decision support software 142 and/or reset controller 140 may, on the other hand, determine that an attempt to recover the hung processor, CPU0 106a in the example, is not desirable or warranted. Instead, the determination may be that a reset of the hung CPU0 106a or reset of the entire SoC 102 is needed. Such determination may be made when one or more previous attempts to recover the hung CPU0 106a have been unsuccessful. In these circumstances reset controller 140 may determine to, or may be caused to, generate a reset command 166 for the particular hung CPU0 106a, such as by issuing a reset command 166 to software 113 as illustrated in FIG. 2. Reset controller 140 may instead determine to, or be caused to, generate a system reset command 168 to reset the entire SoC 102.

The determination whether to reset the hung CPU0 106a or the entire SoC 102 may be made in an embodiment based on information in the hang event notification 155. Information included in the hang event notification 155 may include whether this is the first, second, third, etc., time the particular CPU0 106a has hung, how many times the CPU0 106a has hung in a specified time period, whether/how many attempts to recover the CPU0 106a have been made, whether/how many attempts to reset CPU0 106a have been made, etc.

In the event that the decision is to reset either the CPU0 106a or the entire SoC 102, the present system 200 allows for information near the hung CPU0 106a to be captured and preserved for diagnosis/debugging after the CPU0 106a or SoC 102 is reset. Since core hang controller 150 allows for rapid detection of processor or CPU hang, and detection of such hang conditions close to the hardware issue, such diagnosis information can be more easily preserved without need for large memory stores and/or without fear that subsequent system 200 activity will overwrite the diagnosis information.

For instance, resource power manager 144 may include a logging logic and/or memory such as buffer 145. When a decision is made to reset the CPU0 106a or the SoC 102, current information about the operation of the CPU0 106a, instructions the CPU0 106a was attempting to perform, a power transition that instructions asked the CPU0 106a to make, etc., may be stored in buffer 145. Since this information is near in time and location to the detection of the processor hang at CPU0 106a, the buffer 145 may be relatively small and still capture information related to the CPU0 106a hang that is useful to diagnosing, debugging, trace backs, etc. after CPU0 106a is reset.

As illustrated in FIG. 2, the core hang controller 150 can work in addition to, or in parallel with, system software 113 and/or a traditional watchdog 114 system in communication with interrupt controller 104. Interrupt controller 104 is in communication with CPUs 106a-106n and able to send interrupts to, and receive responses from, CPUs 106a-106n. System software 113 may be operated by one or more of CPUs 106a-106n, or by a dedicated processor. System software 113, may provide interrupts to one or more of CPUs 106a-106n through interrupt controller 104 based on detected issues or problems with one or more CPUs, or based on receiving recovery commands 164 from the resource power manager 144 and/or reset commands 166 from the reset controller 140. For example, system software 113 may include CPU health check software 118 and/or thermal mitigation software 115. Thermal mitigation software 115 may implement various thermal mitigation policies for the SoC 102, and based on inputs from thermal mitigation hardware 160, may provide interrupts to various drivers through interrupt controller 104.

The system 200 may also include a watchdog 114 component in communication with the system software 113 and in communication with the reset controller 140. The watchdog 114 also acts in parallel with the core hang controller 150 and may provide a back-up to the core hang controller 150. Although not illustrated in FIG. 1, watchdog 114 may include its own countdown timer which is generally measured in seconds rather than the μS of timer 154 of core hang controller 152. Watchdog 114 may also provide interrupts or signals to system software 113. In the event that the system software 113 does not act on the interrupts or signals from the watchdog 114, the watchdog 114 may then send a signal 162 to the reset controller 140 that the reset controller 140 may act on to issue a system reset command 168 to the rest of the SoC 102.

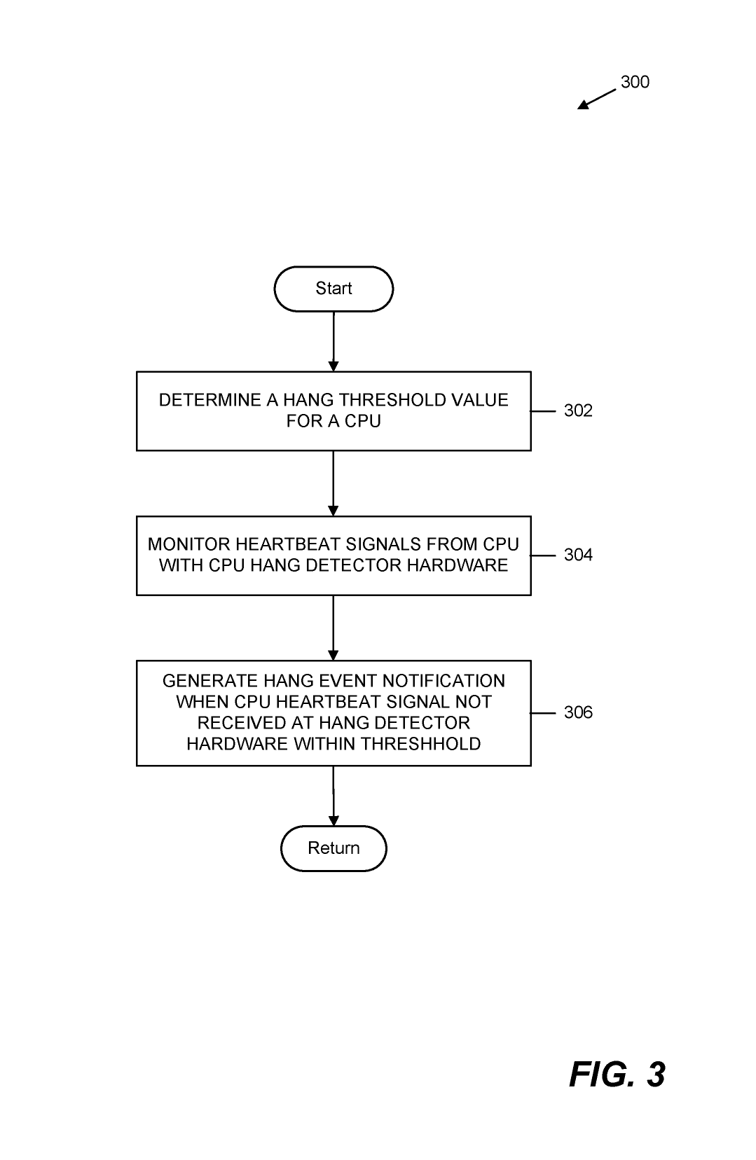

FIG. 3 is a flowchart illustrating an embodiment of a method 300 for providing improved detection of CPU hang. The method 300 begins in block 302 with the determination of a hang threshold value for each processor, such as CPUs 106a-106n of FIG. 1 or FIG. 2, to be monitored for processor or CPU hang. In an embodiment, the hang threshold value in block 302 corresponds to a period of time after which the associated CPU 106a-106n will be deemed hung. The hang threshold value may be determined by the core hang controller 150, or a component of the core hang controller 150. The hang threshold value in block 302 may be determined for each processor at initialization as discussed above with respect for FIG. 2, and may be different for each of CPU 106a-106n or different for each state of each of CPU 106a-106n in various embodiments. The hang threshold value will be measured in μS or mS, and will represent a much shorter time period than used for a SoC 102 watchdog such as watchdog 114 of FIG. 2.

Method 300 continues in block 304 where heartbeat signals, such as heartbeat signals 156a-156n of FIG. 2 from each of CPUs 106a-106n are monitored. In the embodiment of FIG. 3, these heartbeat signals 156a-156n may be monitored with a hardware component of the core hang controller 150, such as detection logic 152. A single core hang controller 150/detection logic 152 hardware may be implemented to monitor all of CPUs 106a-106n as illustrated in FIG. 2. In other embodiments, separate detection logic 152 hardware may be implemented for each of CPUs 106a-106n. Similarly, in other embodiments, separate core hang controllers 150 may be implemented for each of CPUs 106a-106n, with each core hang controller 150 including a separate detection logic 152.

In block 306 a hang event notification is generated when the heartbeat signal 156a-156n for a respective CPU 106a-106n is not received or detected by the detection logic 152 hardware within the threshold period. Block 306 may be implemented as illustrated in FIG. 2 through a timer 154 associated with each of CPUs 106a-106n where the timer 154 has been programmed with the hang threshold value of block 302 for each of CPUs 106a-106n. In such implementations, the timer 154 resets when a heartbeat signal 156a-156n is received for the respective CPU 106a-106n. If the heartbeat signal 156a-156n is not received within the hang threshold period—i.e. before the timer 154 associated with the CPU 106a-106n expires—a hang event notification, such as hang event notification 155 of FIG. 2 is generated. This notification of block 306 may be generated by the core hang controller 150, and in an embodiment is generated by the detection logic 152 hardware of the core hang controller 150. As discussed above for FIG. 2, this hang event notification of block 306 may be provided to various other components of the SoC 102. Method 300 then returns.

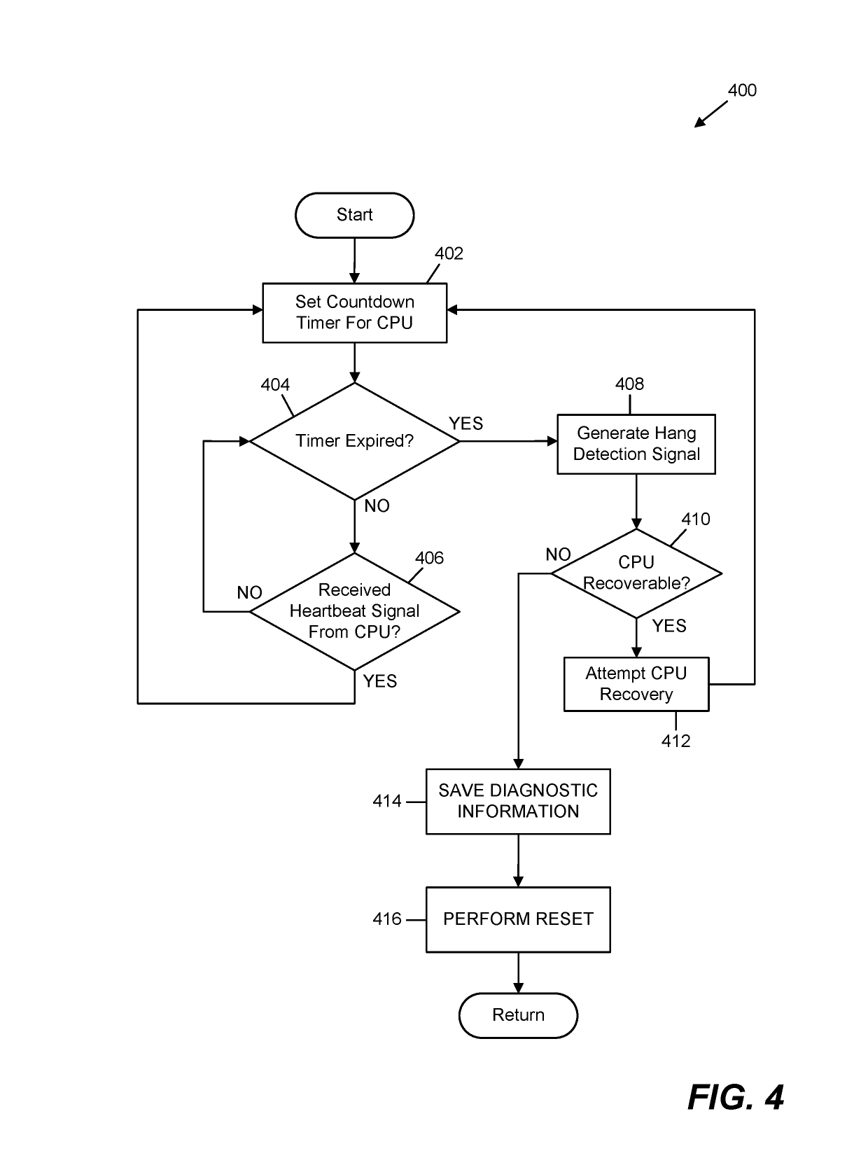

FIG. 4 is a flowchart illustrating an exemplary method 400 for responding to a processor or CPU hang condition. The implementation method 400 of FIG. 4 begins in block 402 where a countdown timer is set for a CPU. Although method 400 is discussed in terms of a single CPU or processor, the blocks of method 400 are equally applicable to systems such as system 100 of FIG. 1 or system 200 of FIG. 2 where multiple CPUs 106a-106n are implemented. It will be understood that in an embodiment blocks of method 400 may be implemented for each of the multiple CPUs 106a-106n separately or at the same time, either sequentially, or in parallel as desired.

Returning to block 402, as illustrated in FIG. 2, the countdown timer may be timer 154 of the core hang controller 150 and may comprise a single timer 154 that tracks each of CPUs 106a-106n. Setting the countdown timer in block 402 may comprise programming the timer 154 with the hang threshold value(s) determined for each of CPUs 106a-106n. As discussed above, setting the countdown timer in block 402 may occur at initialization of the SoC 102. Additionally, in some embodiments the countdown timer may be re-set during operation of the SoC 102.

In block 404 a determination is made whether the countdown timer has expired. This determination may be a determination or recognition by the timer 154 or other component of the core hang controller 150 that timer 154 has reached the threshold value set or programmed for one of CPUs 106a-106n. If the determination in block 404 is that the countdown timer has not expired, method 400 continues to block 406.

A determination is made in block 406 whether a heartbeat signal has been received from the processor or CPU associated with the countdown timer. This heartbeat signal in block 406 may be the heartbeat signal 156a-156n associated with CPUs 106a-106n discussed above for FIG. 2. For such embodiments, the determination in block 406 may be made by a hardware component such as detection logic 152 hardware of the core hang controller 150. Such detection logic 152 may be electrically coupled to the outputs of CPUs 106a-106n in order to receive or monitor heartbeat signals 156a-156n. If the determination in block 406 is that the heartbeat signal has not been received, the detection logic 152 continues to monitor for heartbeat signals and the method 400 returns to block 404 where the timer 154 associated with the CPU(s) 106a-106n is checked.

If the determination in block 406 is that a heartbeat signal has been received for one of CPUs 106a-106n, the method returns to block 402. In block 402, the countdown timer (such as timer 154) associated with the CPU 106a-106n for which the heartbeat signal (such as signals 156a-156n) has been received is re-set. The method 400 then reiterates to block 404 as discussed above. As will be understood, in some embodiments, the order of blocks 404 and 406 may be reversed if desired. In yet other embodiments, blocks 404 and 406 may not be separate steps, but may instead be combined into one determining step or block that checks both the timer 154 (block 404) and whether a heartbeat signal associated with the timer 154 has been received (block 406).

Returning again to block 404, if the determination is that the countdown timer, such as timer 154 for one of CPUs 106a-106n has expired, the method 400 continues to block 408 where a hang detection signal is generated. In an embodiment block 408 may comprise the core hang controller 150, or a component thereof such as detection logic 152 hardware, generating a hang event notification 155 identifying the CPU 106a-106n for which a hang condition has been determined/detected.

In block 410 a determination is made whether the hung CPU 106a-106n may be recovered. In an embodiment the determination in block 410 may be made by the core hang controller 150. In these embodiments, the hang detection signal (hang event notification 155) may include information or instructions to take action in response to the determination in block 410.

In other embodiments, the determination in block 410 may be made by one or more of a resource power manager 144, decision support software 142, or reset controller 140 (or by a combination of these components). In such embodiments, the determination in block 410 may be based at least in part on information contained in the hang detection signal (hang event notification 155) generated in block 408. Information on which the determination in block 410 may be in part based includes, whether this is the first, second, third, etc., time the particular CPU 106a-106n associated with the hang detection signal of block 408 has hung, how many times the CPU 106a-106n has hung in a specified time period, whether/how many attempts to recover the CPU 106a-106n have been made, whether/how many attempts to reset CPU 106a-106n have been made, etc.

If the determination in block 410 is that the CPU 106a-106n is recoverable, or at least that the attempt to recover the CPU 106a-106n should be made, method 400 continues to block 412 where recover of CPU 106a-106n is attempted. In an embodiment, the recover attempt in block 412 may comprise the resource power manager 144 sending a recovery command 164 to cause an interrupt from interrupt controller 104. As illustrated in FIG. 2, such recovery command 164 may be sent to interrupt controller 104 through system software 113 in an embodiment. Method 400 then returns to block 402 where the countdown timer for CPU 106a-106n is reset. Method 400 then continues as described above, and the core hang controller 150 monitors the CPU 106a-106n for a heartbeat signal 156a-156n that indicates the CPU 106a-106n has successfully recovered.

Returning to block 410, if the determination is that the CPU 106a-106n is not recoverable, or at least that an attempt or further attempt to recover the CPU 106a-106n should not be made, method 400 continues to block 414. In block 414 diagnostic information is saved, such as in buffer 145 of the resource power manager 144 as discussed above for FIG. 2. Method 416 then continues to block 416 where the reset is performed. In an embodiment, the reset in block 416 may comprise resetting the CPU 106a-106n such as with a reset command 166 from reset controller 140 of FIG. 2.

Alternatively, the reset in block may comprise resetting the SoC 102, such as with a system reset command 168 from the reset controller 140 as shown in FIG. 2. As will be understood, performing the reset in block 416 may include determining which of the CPU 106a-106n reset or the SoC 102 reset should be performed. Such determination may have been previously made by core hang controller 150 and communicated by the hang detection signal (hang event notification 155). In other embodiments, the determination may be made by reset controller 140, decision support software 142, and/or resource power manager 145 (or a combination of these components). Regardless of which reset is performed in block 416 the method 400 returns as resetting the CPU 106a-106n or SoC 102 may require re-initializing the CPU 106a-106n such that a new hang threshold value may need to be determined for the CPU 106a-106n (see FIG. 3).

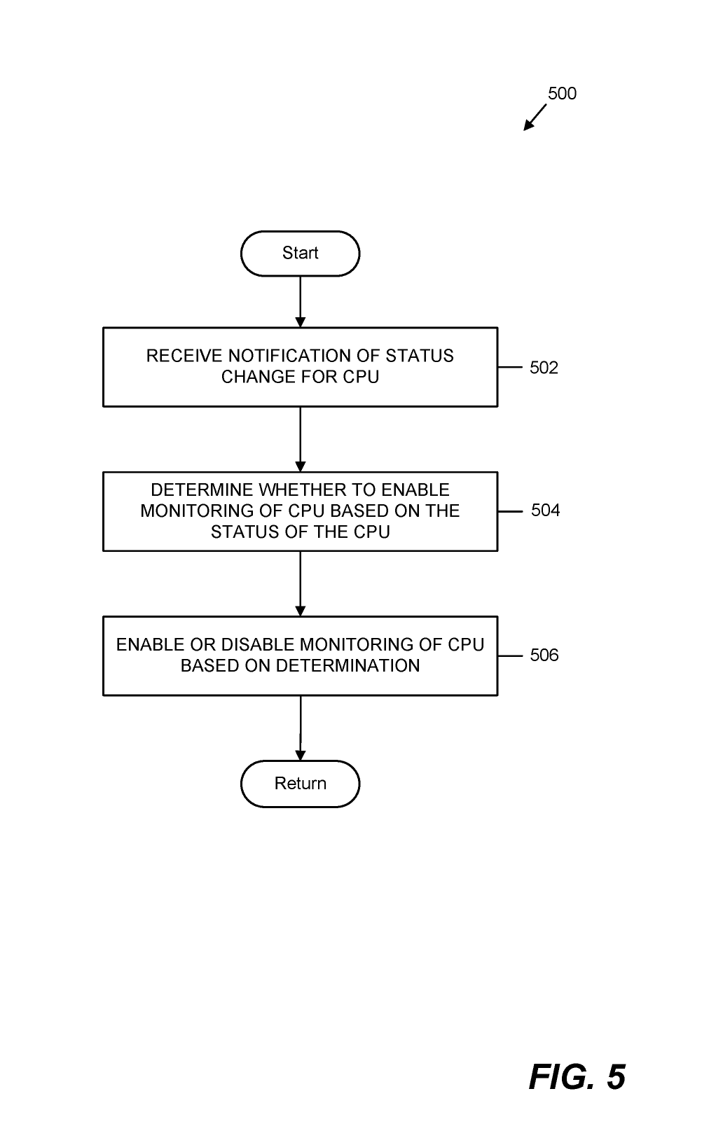

FIG. 5 is a flowchart illustrating an additional method 500 for providing improved detection of processor hang. As will be understood, at various times it may not be advantageous or desirable to try and detect processor or CPU hang for any or all of CPUs 106a-106n. For example, in a situation where a CPU0 106a for example is inactive because it has been placed in a low power or reduced power mode, there is no need to check whether CPU0 106a is hung. Similarly, if CPU0 106a has been placed into a debug mode, such as by a user, where CPU0 106a is not operating normally there is also no need to check whether CPU0 106a is hung.

At other times when the CPU0 106a is not currently being monitored to see if it is hung, it may be desirable to begin monitoring CPU0 106a at some point. For example, it CPU0 106a is in a low power mode of state and is transitioning back into a full power or normal operational mode or state, it is desirable to begin monitoring CPU0 106a to see if it is hung, both as CPU0 106a is transitioning, and once CPU0 106a reaches the normal operational mode or state.

Exemplary method 500 allows a system, such as system 100 of FIG. 1 or system 200 of FIG. 2, to enable or disable monitoring of processor or CPU hang and/or to change the hang threshold value for the CPU0 106a based on the operational mode or state of the CPU0 106a. Although discussed in terms of CPU0 106a, the below discussion of method 500 is equally applicable to multiple processors or CPUs, such as CPUs 106a-106n of FIG. 1 and FIG. 2. It will be understood that in such an embodiment, the blocks of method 500 may be implemented for each of the multiple CPUs 106a-106n separately or at the same time, either sequentially, or in parallel as desired.

Method 500 begins in block 502 where a notification of a change in status for CPU0 106a is received. The notification may be received at the core hang controller 150 from CPU0 106a in an embodiment. The status change may represent in some embodiments a change in power level, such as CPU0 106a being placed into a low or reduced power state or mode. The status change may conversely represent the CPU0 106a waking up from a low or reduced power state or mode into a normal or fully powered state. Additionally, the status change may represent CPU0 106a being placed into a debugging or other state or mode where monitoring CPU0 106a for a hang condition is not needed or less important. The state change may also represent CPU0 106a returning from such debugging mode or other state or mode into a normal or fully operational mode or state where monitoring is desired.

In block 504 a determination is made whether to enable (or disable) monitoring of CPU0 106a based on the received status information. The determination in block 504 may be made in an embodiment by the core hang controller 150 or a component thereof. The determination in block 504 may comprise a determination whether CPU0 106a is to be monitored for processor hang at all based on the received status information. The determination in block 504 may also compromise a determination of a hang threshold value (see FIG. 3, block 302) based at least in part on the received status information.

Method 500 continues to block 506 where the monitoring of CPU0 106a is enabled (or disabled) based on and in accordance with the determination of block 504. In and embodiment, enabling the monitoring of CPU0 106a may comprise beginning the method 400 of FIG. 4 discussed above. In such embodiments, in the first block 402 of method 400, the countdown timer, such as timer 145 may be set with the hang threshold value determined in block 504 of method 500. In other embodiments disabling the monitoring of CPU0 106a may comprise ceasing the method 400 of FIG. 4, such as by ceasing the countdown timer 145.

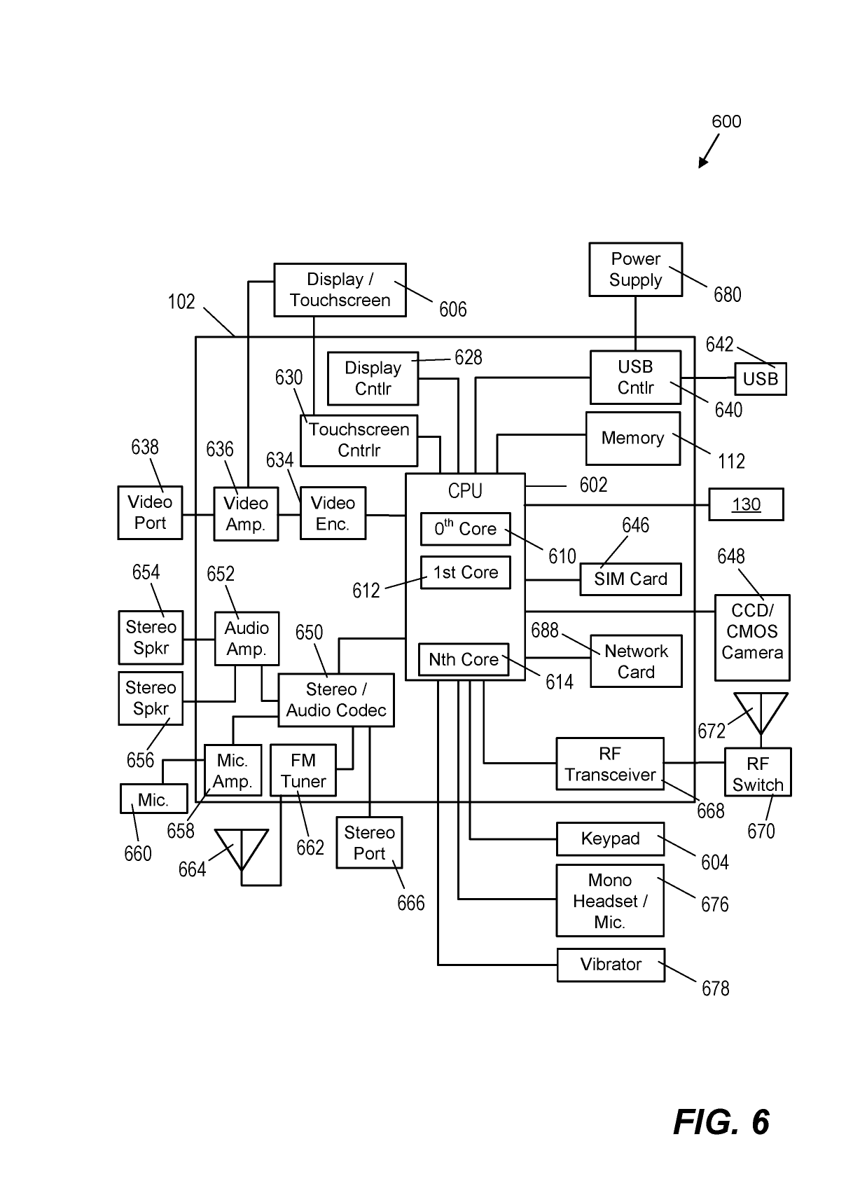

Systems 100 (FIG. 1) and 200 (FIG. 2), as well as methods 300 (FIG. 3), 400 (FIG. 4) and/or 500 (FIG. 5) may be incorporated into or performed by any desired computing system, including a PCD. FIG. 6 illustrates an exemplary PCD 600 into which systems 100 and/or 200 may be incorporated, or that may perform methods 300, 400, and/or 500. In the embodiment of FIG. 6, the SoC 102 may include a multicore CPU 602. The multicore CPU 602 may include a zeroth core 610, a first core 612, and an Nth core 614, which may be CPUs 106a-106n of FIG. 1 or FIG. 2. One of the cores may comprise, for example, a graphics processing unit (GPU) with one or more of the others comprising the CPU.

A display controller 628 and a touch screen controller 630 may be coupled to the CPU 602. In turn, the touch screen display 606 external to the on-chip system 102 may be coupled to the display controller 628 and the touch screen controller 630. FIG. 6 further shows that a video encoder 634, e.g., a phase alternating line (PAL) encoder, a sequential color a memoire (SECAM) encoder, or a national television system(s) committee (NTSC) encoder, is coupled to the multicore CPU 602. Further, a video amplifier 636 is coupled to the video encoder 634 and the touch screen display 606.

Also, a video port 638 is coupled to the video amplifier 636. As shown in FIG. 6, a universal serial bus (USB) controller 640 is coupled to the multicore CPU 602. Also, a USB port 642 is coupled to the USB controller 640. Memory 112 and a subscriber identity module (SIM) card 646 may also be coupled to the multicore CPU 602.

Further, as shown in FIG. 6, a digital camera 648 may be coupled to the multicore CPU 602. In an exemplary aspect, the digital camera 648 is a charge-coupled device (CCD) camera or a complementary metal-oxide semiconductor (CMOS) camera.

As further illustrated in FIG. 6, a stereo audio coder-decoder (CODEC) 650 may be coupled to the multicore CPU 602. Moreover, an audio amplifier 652 may be coupled to the stereo audio CODEC 650. In an exemplary aspect, a first stereo speaker 654 and a second stereo speaker 656 are coupled to the audio amplifier 652. FIG. 6 shows that a microphone amplifier 658 may be also coupled to the stereo audio CODEC 650. Additionally, a microphone 660 may be coupled to the microphone amplifier 658. In a particular aspect, a frequency modulation (FM) radio tuner 662 may be coupled to the stereo audio CODEC 650. Also, an FM antenna 664 is coupled to the FM radio tuner 662. Further, stereo headphones 666 may be coupled to the stereo audio CODEC 650.

FIG. 6 further illustrates that a radio frequency (RF) transceiver 668 may be coupled to the multicore CPU 602. An RF switch 670 may be coupled to the RF transceiver 668 and an RF antenna 672. A keypad 604 may be coupled to the multicore CPU 602. Also, a mono headset with a microphone 676 may be coupled to the multicore CPU 602. Further, a vibrator device 678 may be coupled to the multicore CPU 602.

FIG. 6 also shows that a power supply 680 may be coupled to the on-chip system 102. In a particular aspect, the power supply 680 is a direct current (DC) power supply that provides power to the various components of the PCD 600 that require power. Further, in a particular aspect, the power supply is a rechargeable DC battery or a DC power supply that is derived from an alternating current (AC) to DC transformer that is connected to an AC power source.

FIG. 6 further indicates that the PCD 600 may also include a network card 688 that may be used to access a data network, e.g., a local area network, a personal area network, or any other network. The network card 688 may be a Bluetooth network card, a WiFi network card, a personal area network (PAN) card, a personal area network ultra-low-power technology (PeANUT) network card, a television/cable/satellite tuner, or any other network card well known in the art. Further, the network card 688 may be incorporated into a chip, i.e., the network card 688 may be a full solution in a chip, and may not be a separate network card 688.

Referring to FIG. 6, it should be appreciated that the memory 130, touch screen display 606, the video port 638, the USB port 642, the camera 648, the first stereo speaker 654, the second stereo speaker 656, the microphone 660, the FM antenna 664, the stereo headphones 666, the RF switch 670, the RF antenna 672, the keypad 674, the mono headset 676, the vibrator 678, and the power supply 680 may be external to the on-chip system 102 or “off chip.”

It should be appreciated that one or more of the method steps described herein may be stored in the memory as computer program instructions. These instructions may be executed by any suitable processor in combination or in concert with the corresponding module to perform the methods described herein.

Certain steps in the processes or process flows described in this specification naturally precede others for the invention to function as described. However, the invention is not limited to the order of the steps or blocks described if such order or sequence does not alter the functionality of the invention. That is, it is recognized that some steps or blocks may performed before, after, or parallel (substantially simultaneously with) other steps or blocks without departing from the scope and spirit of the invention. In some instances, certain steps or blocks may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, NAND flash, NOR flash, M-RAM, P-RAM, R-RAM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Alternative embodiments will become apparent to one of ordinary skill in the art to which the invention pertains without departing from its spirit and scope. Therefore, although selected aspects have been illustrated and described in detail, it will be understood that various substitutions and alterations may be made therein without departing from the spirit and scope of the present invention, as defined by the following claims.

What is claimed is:

1. A method for implementing processor hang detection, the method comprising:
setting a timer with a hang threshold value for each of a plurality of processors of a system on a chip (SoC), the hang threshold value representing a time in microseconds;
receiving a first heartbeat signal from each of the plurality of processors with a detection logic hardware of a hang controller coupled to the plurality of processors and to the timer;
resetting the timer for each of the plurality of processors if a second heartbeat signal is received from the corresponding one of the plurality of processors before the timer expires, or
generating a hang event notification with the hang controller if the second heartbeat signal is not received from the corresponding one of the plurality of processors before the timer expires.

2. The method of claim 1, further comprising:
sending a software interrupt from a watchdog component separate from the hang controller to an interrupt controller in communication with the plurality of processors;
monitoring a software timer of the watchdog component, the software timer measured in a plurality of seconds; and
sending a signal from the watchdog component to reset the SoC if the software timer of the watchdog component expires.

3. The method of claim 1, wherein the hang event notification identifies a first processor of the plurality of processors, the first processor in a hung condition.

4. The method of claim 3, further comprising:
receiving the hang notification event at a resource power manager in communication with the hang controller; and
determining to send a recovery signal for the first processor from the resource power manager to a system software in communication with the interrupt controller in response to the hang event notification.

5. The method of claim 3, further comprising:
receiving the hang notification event at a reset controller in communication with the hang controller; and
determining to send a reset signal from the reset controller.

6. The method of claim 5, wherein the reset signal comprises a reset signal for the first processor and the reset signal is sent from the reset controller to the system software.

7. The method of claim 5, wherein the reset signal comprises an SoC reset signal to reset the SoC.

8. The method of claim 5, further comprising:
generating diagnostic information with the hang controller before the reset signal is sent from the reset controller.

9. The method of claim 8, further comprising:
saving the diagnostic information in a memory of the resource power manager.

10. The method of claim 1, further comprising:
receiving at the detection logic hardware of the hang controller a notification of a change in status for a second of the plurality of processors; and
determining whether to disable the timer for the second of the plurality of processors based on the received notification.

11. A computer system for improved processor hang detection in a portable computing device (PCD), the system comprising:
a system-on-a-chip (SoC) with a plurality of processors, each of the plurality of processors configured to generate a heartbeat signal indicating that the respective one of the plurality of processors is programmatically executing instructions; and
a hang controller in communication with each of the plurality of processors, the hang controller comprising:
a timer, the timer set with a hang threshold value for each of the plurality of processors, the hang threshold value representing a time in microseconds, and
a detection logic hardware in communication with the timer and the plurality of processors, the detection logic hardware configured to receive a first heartbeat signal from each of the plurality of processors and to:
reset the timer for each of the plurality of processors if a second heartbeat signal is received from the corresponding one of the plurality of processors before the timer expires, or
generate a hang event notification if the second heartbeat signal is not received from the corresponding one of the plurality of processors before the timer expires.

12. The system of claim 11, further comprising:
an interrupt controller in communication with each of the plurality of processors;
a watchdog component in communication with the interrupt controller, the watchdog component separate from the hang controller, the watchdog component including a software timer measured in a plurality of seconds, and the watchdog component configured to send a signal to reset the SOC if the software timer expires.

13. The system of claim 11, wherein the hang event notification identifiers a first processor of the plurality of processors, the first processor in a hung condition.

14. The system of claim 13, further comprising:
a resource power manager in communication with the hang controller, the resource power manager configured to receive the hang notification event and determine to generate a recovery signal for the first processor in response to the hang event notification.

15. The system of claim 13, further comprising:
a reset controller in communication with the hang controller, the reset controller configured to receive the hang notification event and determine to generate a reset signal in response to the hang event notification.

16. The system of claim 15, wherein the reset signal comprises a reset signal for the first processor and the reset signal is sent to a system software in communication with the interrupt controller.

17. The system of claim 15, wherein the reset signal comprises an SoC reset signal to reset the SoC.

18. The system of claim 5, wherein the detection logic hardware is further configured to generate diagnostic information related to the first processor.

19. The system of claim 18, wherein the resource power manager is further configured to receive the diagnostic information from the detection logic hardware and store the received diagnostic information.

20. The system of claim 11, wherein
a second processor of the plurality of processors is configured to send a notification of a change in status of the second processor to the detection logic hardware, and
the detection logic hardware is further configured to determine whether to disable the timer for the second processor based on the received notification.

21. A computer program product comprising a non-transitory computer usable medium having a computer readable program code embodied therein, said computer readable program code adapted to be executed to implement a method for improved processor hang detection in a portable computing device (PCD), the method comprising:
setting a timer with a hang threshold value for each of a plurality of processors of a system on a chip (SoC), the hang threshold value representing a time in microseconds;
receiving a first heartbeat signal from each of the plurality of processors with a detection logic hardware of a hang controller coupled to the plurality of processors and to the timer;
resetting the timer for each of the plurality of processors if a second heartbeat signal is received from the corresponding one of the plurality of processors before the timer expires, or
generating a hang event notification with the hang controller if the second heartbeat signal is not received from the corresponding one of the plurality of processors before the timer expires.

22. The computer program product of claim 21, further comprising:
sending a software interrupt from a watchdog component separate from the hang controller to an interrupt controller in communication with the plurality of processors;
monitoring a software timer of the watchdog component, the software timer measured in a plurality of seconds; and
sending a signal from the watchdog component to a reset the SoC if the software timer of the watchdog component expires.

23. The computer program product of claim 21, wherein the hang event notification identifies a first processor of the plurality of processors, the first processor in a hung condition.

24. The computer program product of claim 23, further comprising:
receiving the hang notification event at a resource power manager in communication with the hang controller; and
determining to send a recovery signal for the first processor from the resource power manager to a system software in communication with the interrupt controller in response to the hang event notification.

25. The computer program product of claim 23, further comprising:
receiving the hang notification event at a reset controller in communication with the hang controller; and
determining to send a reset signal from the reset controller.

26. A computer system for improved processor hang detection in a portable computing device (PCD), the system comprising:
means for setting a timer with a hang threshold value for each of a plurality of processors of a system on a chip (SoC), the hang threshold value representing a time in microseconds;
means for receiving a first heartbeat signal from each of the plurality of processors with a detection logic hardware of a hang controller coupled to the plurality of processors and to the timer;
means for resetting the timer for each of the plurality of processors if a second heartbeat signal is received from the corresponding one of the plurality of processors before the timer expires, or
means for generating a hang event notification with the hang controller if the second heartbeat signal is not received from the corresponding one of the plurality of processors before the timer expires.

27. The system of claim 26, further comprising:
means for sending a software interrupt from a watchdog component separate from the hang controller to an interrupt controller in communication with the plurality of processors;
means for monitoring a software timer of the watchdog component, the software timer measured in a plurality of seconds; and
means for sending a signal from the watchdog component to a reset the SoC if the software timer of the watchdog component expires.

28. The system of claim 26, wherein the hang event notification identifies a first processor of the plurality of processors, the first processor in a hung condition.

29. The system of claim 28, further comprising:
means for receiving the hang notification event at a resource power manager in communication with the hang controller; and
means for determining to send a recovery signal for the first processor from the resource power manager to a system software in communication with the interrupt controller in response to the hang event notification.

30. The system of claim 28, further comprising:
means for receiving the hang notification event at a reset controller in communication with the hang controller; and
means for determining to send a reset signal from the reset controller.
